(19) United States
(12) Patent Application Publication
(10) Pub. No.: US 2013/0062569 A1
(43) Pub. Date: Mar. 14, 2013

(54) PROTEIN-FREE SOLUTION FOR NON-PROGRAMMED CELL CRYOPRESERVATION

(71) Applicants: Xiaoying Mo, Guangzhou (CN); Dunwu Zheng, Guangzhou (CN); Baoli Wei, Guangzhou (CN); Jiahui Chen, Guangzhou (CN); Qingyan Luo, Guangzhou (CN)

(72) Inventors: Xiaoying Mo, Guangzhou (CN); Dunwu Zheng, Guangzhou (CN); Baoli Wei, Guangzhou (CN); Jiahui Chen, Guangzhou (CN); Qingyan Luo, Guangzhou (CN)

(21) Appl. No.: 13/695,729

(22) PCT Filed: Jul. 31, 2010
(86) PCT No.: PCT/CN10/75614

§ 371 Date: Nov. 1, 2012

(30) Foreign Application Priority Data
May 26, 2010 (CN) 201010183903.X

(51) Int. Cl. C09K 15/00; C09K 15/28; C09K 15/06

(52) U.S. Cl. 252/406; 252/397; 252/407

(57) ABSTRACT

The invention provides a protein-free solution for cell cryopreservation, which comprises 1-23 w/v % of cell membrane protectant, 1.0-16 w/v % of permeable intracellular protectant, 3.0-28 w/v % of cell sedimentation stabilizer, and the balance of pH buffer solution. The cell cryopreservation solution of the invention consists of chemical substances only, without any protein content. The components are stable and controllable. The cell cryopreservation solution has long shelf life, high stability between different batches and good protection of cells, and has no effect on the characteristics, normal growth and differentiation of cells; besides, the recovery rate of the cells cryopreserved by the cell cryopreservation solution is high. The cell cryopreservation solution of the invention can be used directly without additional preparation or dilution steps, thus the cryopreservation process is simple, just needing to add cells in the cell cryopreservation solution and putting the solution in an environment of −80 DEG C directly.

### TECHNICAL FIELD OF THE INVENTION

The invention relates to a solution for cell cryopreservation, and in particular to a protein-free solution for cell cryopreservation.

### BACKGROUND OF THE INVENTION

Cells, particularly high-value cells such as stem cells, have potential additional values like medical values. Cell preservation technology is the basis of realizing these values.

The commonly used cell preservation method includes culture preservation and cryopreservation. The culture preservation is labour-intensive and time-consuming, with cumbersome procedures; during the culture process, particularly the long-term subculture process, cells get mutated easily, thus, cellular characteristics are missing and the preservation has no meaning. Therefore, the culture preservation generally is applied to the cells which are easily cultured and difficulty mutated, such as part tumour cells.

The cell cryopreservation is to put cells in a low-temperature environment for preservation, so that the cells stop growing temporarily and remain the characteristics. This method has a relatively low cost and the cells can be cultured to recover when needed; at the same time, the loss of cell varieties caused by cell contamination in the culture preservation is avoided.

An existing cell cryopreservation solution generally consists of Dimethyl Sulfoxide (DMSO), serum and cell culture fluid, wherein this solution is a ready-to-use cryopreservation solution and is used right after it was ready; since the components of the serum is instable, batch-to-batch stability of the cryopreservation solution is low. Moreover, the existence of serum protein makes the shelf time of the cell cryopreservation solution shorter and requires demanding preservation conditions.

The existence of protein in the cell cryopreservation solution has certain impact on the characteristics of cells, for example, some components in the serum would impact the growth and differentiation of cells (for example, special cells such as Neural Stem Cells (NSCs) and neuronal cells).

In cell therapy, the existence of heterologous protein, particularly unknown protein, would cause unnecessary, even unknown side effects, thereby seriously influencing the therapy result. People expect that the cryopreservation of the cells for cell therapy is not added with heterologous protein at least. However, if no heterologous protein is added, the recovery rate of the cryopreserved cells is difficultly guaranteed.

Even if protein protectant is added in the cells, in order to guarantee the success rate of the cell cryopreservation, it is still necessary to adopt a programmed cooling process to cryopreserve the cells slowly when using this cell cryopreservation solution to cryopreserve the cells. The programmed cooling process needs a long time and an expensive special instrument; however, the programmed cooling process has a limited processing capacity, can only be used for small-batch processing in laboratories and can not meet the requirement of large-batch processing.

### SUMMARY OF THE INVENTION

The purpose of the invention is to provide a protein-free solution for non-programmed cell cryopreservation.

The invention adopts the technical scheme as follows.

The invention provides a protein-free solution for cell cryopreservation, which comprises 1.0-23 w/v % of cell membrane protectant, 1.0-16 w/v % of permeable intracellular protectant, 3.0-28 w/v % of cell sedimentation stabilizer, and the balance of solvent.

Preferably, the cryopreservation solution further comprises 0.1-0.4 w/v % of antioxidant and 0.3-2.0 w/v % of cell nutritional agent.

The cell membrane protectant comprises non-reducing disaccharide, polysaccharide and sugar anhydride.

The invention has advantages as follows:

in the cell cryopreservation solution of the invention, the components are completely clear, without any protein substance; each component used in the solution is organism acceptable, causing no damage to matrix, at leas causing no unknown damage to the matrix; thus, the cell cryopreservation solution of the invention is particularly suitable for the cryopreservation of cells for cell therapy;

the cell cryopreservation solution of the invention has good protection for cells and the recovery rate of the cryopreserved cells is high; experiments show that the recovery rate of Mesenchymal Stem Cells (MSCs) cryopreserved by the cell cryopreservation solution of the invention is over 90%, the recovery rate of Cortical Neuron Cells (CNCs) cryopreserved by the cell cryopreservation solution of the invention is over 75%, and the recovery rate of Embryonic Stem Cells (ESCs) cryopreserved by the cell cryopreservation solution of the invention is over 94%. Besides the excellent cryopreservation effect, the cell cryopreservation solution of the invention has no impact on the characteristics, normal growth and differentiation of cells too;

with the cell cryopreservation solution of the invention, the cryopreservation process is simple, just needing to add cells to be cryopreserved in the cell cryopreservation solution and putting the solution in an environment of −80 DEG C directly; there is no need for programmed cooling process and the efficiency of cell cryopreservation is greatly enhanced;

the cell cryopreservation solution of the invention consists of chemical substances only; the components are stable and controllable; the cell cryopreservation solution has long shelf life, high stability between different batches, can be used for cell cryopreservation directly without additional preparation or dilution steps, thus the operation is greatly convenient.

### BRIEF DESCRIPTION OF THE DRAWINGS

FIG. 1 shows a growth curve of recovered MSCs of an SD rat;

FIG. 2 shows a cells diagram of non-induced MSCs of the SD rat;

FIG. 3 shows a cells diagram of the MSCs of the SD rat subjected to osteoblast induction for 28 d after the MSCs are recovered from the cryopreservation of the cell cryopreservation solution provided by the invention;

FIG. 4 shows a cells diagram of the MSCs of the SD rat subjected to osteoblast induction for 28 d after the MSCs are recovered from the programmed cryopreservation of a conventional cell cryopreservation solution;

FIG. 5 shows a cells diagram of the MSCs of the SD rat subjected to osteoblast induction for 28 d after the MSCs are recovered from the non-programmed cryopreservation of the conventional cell cryopreservation solution;

FIG. 6 shows a cells diagram of the MSCs of the SD rat subjected to lipoblast induction for 20 d after the MSCs are recovered from the cryopreservation of the cell cryopreservation solution provided by the invention;

FIG. 7 shows a cells diagram of the MSCs of the SD rat subjected to lipoblast induction for 20 d after the MSCs are recovered from the programmed cryopreservation of the conventional cell cryopreservation solution; and

FIG. 8 shows a cells diagram of the MSCs of the SD rat subjected to lipoblast induction for 20 d after the MSCs are recovered from the non-programmed cryopreservation of the conventional cell cryopreservation solution.

### DETAILED DESCRIPTION OF THE PREFERRED EMBODIMENTS

The cell membrane protectant, the permeable intracellular protectant and the cell sedimentation stabilizer used in the invention can be used separately or in a mixed way according to requirements.

The permeable intracellular protectant used in the invention comprises DMSO, propylene glycol and glycerin.

The cell sedimentation stabilizer used in the invention comprises methylcellulose, hydroxyethyl starch, dextrin and soluble starch, and is used to prevent or delay the sedimentation of cells in the cryopreservation process, and to avoid cell cryopreservation being influenced by mutual extrusion of cells.

The pH buffer solution used in the cell cryopreservation solution of the invention is to provide a stable pH suitable for the survival of cells, and can be a conventional Phosphate Buffered Saline (PBS) buffer solution, wherein the pH value of the buffer solution and the content of Na+ and K+ can be adjusted according to the specific type of cells to be cryopreserved. The adjustment is well known by those skilled in the art. The commonly used pH buffer solution has a pH of between 7.2 and 7.4, a Na+ content of between 20 mM and 30 mM, and a K+ content of between 110 mM and 130 mM.

The antioxidant used in the cell cryopreservation solution of the invention is a conventional antioxidant, including vitamin C and glutathione, wherein the antioxidant can be used separately or in a mixed way. Those skilled in the art can select other antioxidants according to requirements.

The cell nutritional agent used in the cell cryopreservation solution of the invention is a conventional cell nutritional agent, including glutamine, sodium pyruvate and so on, and is used to compensate part energy consumed by cellular metabolism. The cell nutritional agent can be used separately or in a mixed way. Those skilled in the art can select other cell nutritional agents according to requirements.

The invention is described below in further detail in conjunction with embodiments.

In the following embodiments, percentage refers to w/v % if there is no special illustration.

### Embodiment 1

Constitutes of the cell cryopreservation solution are as follows:

1% of cell membrane protectant, which consists of 0.5% of cane sugar and 0.5% of high-molecule sugar anhydride-500;

8% of DMSO;

25% of cell sedimentation stabilizer, which consists of 15% of methyl cellulose 4000 CP and 10% of hydroxyethyl starch;

0.2% of antioxidant, which consists of 0.1% of vitamin C and 0.1% of glutathione;

1.0% of cell nutritional agent, which consists of 0.4% of glutamine and 0.6% of sodium pyruvate;

the balance of PBS buffer solution.

### Embodiment 2

Constitutes of the cell cryopreservation solution are as follows:

23% of cell membrane protectant, which consists of 11% of trehalose, 5% of panose and 7% of middle-molecule sugar anhydride-70;

5% of permeable intracellular protectant, which consists of 2% of propylene glycol and 3% of glycerin;

8% of cell sedimentation stabilizer, which consists of 5% of soluble starch and 3% of dextrin;

0.3% of glutathione;

0.3% of glutamine;

the balance of PBS buffer solution.

### Embodiment 3

Constitutes of the cell cryopreservation solution are as follows:

5% of cell membrane protectant, which consists of 2% of trehalose and 3% of xylose;

13% of permeable intracellular protectant, which consists of 5% of DMSO and 8% of propylene glycol;

20% of cell sedimentation stabilizer, which consists of 5% of methyl cellulose 1500 CP and 15% of hydroxyethyl starch;

0.1% of antioxidant, which consists of vitamin C;

0.5% of cell nutritional agent, which consists of sodium pyruvate;

the balance of pH buffer solution.

### Embodiment 4

Constitutes of the cell cryopreservation solution are as follows:

17% of cell membrane protectant, which consists of trehalose;

16% of permeable intracellular protectant, which consists of DMSO;

2% of cell sedimentation stabilizer, which consists of methyl cellulose 4000 CP;

0.2% of antioxidant, which consists of vitamin C;

0.8% of cell nutritional agent, which consists of 0.1% glutamine and 0.7% sodium pyruvate;

the balance of pH buffer solution.

### Embodiment 5

Constitutes of the cell cryopreservation solution are as follows:

10% of cell membrane protectant, which consists of 6.0% of trehalose and 4.0% of cane sugar;

9% of permeable intracellular protectant, which consists of glycerin;

23% of cell sedimentation stabilizer, which consists of 18% of methyl cellulose 400 CP and 5% of soluble starch;

0.4% of antioxidant, which consists of 0.12% of vitamin C and 0.28% of glutathione;

2% of cell nutritional agent, which consists of 1.0% of glutamine and 1.0% of sodium pyruvate;

the balance of pH buffer solution.

### Embodiment 6

Constitutes of the cell cryopreservation solution are as follows:

14% of cell membrane protectant, which consists of 4% of raffinose, 3% of xylose and 7% of panose;

1% of permeable intracellular protectant, which consists of DMSO;

13% of cell sedimentation stabilizer, which consists of 8% of methyl cellulose 1500 CP and 5% of hydroxyethyl starch;

0.1% of antioxidant, which consists of vitamin C;

1.5% of cell nutritional agent, which consists of sodium pyruvate;

the balance of pH buffer solution.

### Embodiment 7

Constitutes of the cell cryopreservation solution are as follows:

7% of cell membrane protectant, which consists of 1% of sugar anhydride-40, 3% of raffinose and 3% of cane sugar;

10% of permeable intracellular protectant, which consists of DMSO;

17% of cell sedimentation stabilizer, which consists of soluble starch;

0.26% of antioxidant, which consists of glutathione;

1.8% of cell nutritional agent, which consists of glutamine;

the balance of pH buffer solution.

Using the cell cryopreservation solution with different proportions of cell membrane protectant to carry out non-programmed cryopreservation of MSCs of an SD rat, and detecting the recovery rate, wherein the result is as shown in Table 1.

TABLE 1
comparison table for portions of cell membrane protectant
and cell recovery rates

| | Component | Amount | | | | |
|---|---|---|---|---|---|---|
| Cell membrane | Raffinose | 0.3% | 1.2% | 13% | 18% | 37% |
| protectant | Sugar | 1.0% | 3.0% | 16% | 27% | 39% |
| | anhydride-40 | | | | | |

| | | |
|---|---|---|
| Permeable | DMSO | 5.0% |
| intracellular | | |
| protectant | | |
| Antioxidant | Vitamin C | 0.27% |
| Cell | Methyl cellulose | 6.0% |
| sedimentation | 4000CP | |
| stabilizer | | |
| Cell nutritional | Glutamine | 2.0% |
| agent | Sodium pyruvate | 1.3% |
| pH buffer | PBS | The balance |
| solution | | |

| | | | | | |
|---|---|---|---|---|---|
| Cell recovery rate (%) | 68.7 | 98.2 | 98.0 | 97.8 | 78.0 |

In Table 1, the cell membrane protectant is used separately; from the data in Table 1, it can be seen that the amount has a certain impact on the cell recovery rate. When the amount of the cell membrane protectant is between 1.2% and 27%, the cell recovery rate is relatively higher; in consideration of other experimental data and the variety of cells cryopreserved, the amount of the cell membrane protectant preferably is between 1.0% and 23% in this invention.

Using the cell cryopreservation solution with different proportions of permeable intracellular protectant to carry out non-programmed cryopreservation of the MSCs of an SD rat, and detecting the recovery rate, wherein the result is as shown in Table 2.

TABLE 2
comparison table for portions of permeable intracellular
protectant and cell recovery rates

| | Component | Amount | | | | |
|---|---|---|---|---|---|---|
| Cell membrane | Sugar | 5.0% | | | | |
| protectant | anhydride-40 | | | | | |
| Permeable | DMSO | 1.0% | 3.0% | 8% | 13% | 27% |
| intracellular | | | | | | |
| protectant | | | | | | |

| | | |
|---|---|---|
| Antioxidant | Vitamin C | 0.3% |
| Cell sedimentation | Methyl | 8.0% |
| stabilizer | cellulose | |
| | 4000CP | |
| | Hydroxyethyl | 6.0% |
| | starch | |
| Cell nutritional | Glutamine | 1.0% |
| agent | Sodium | 0.33% |
| | pyruvate | |
| pH buffer solution | PBS | The balance |

| | | | | | |
|---|---|---|---|---|---|
| Cell recovery rate (%) | 82.1 | 97.1 | 96.8 | 93.4 | 61.2 |

From the data in Table 2, it can be seen that the cell recovery rate is relatively higher when the amount of the permeable intracellular protectant is between 3% and 13%; based on an overall consideration, the amount of the permeable intracellular protectant preferably is between 1% and 16% in the cell cryopreservation solution of the invention.

Using the cell cryopreservation solution with different proportions of cell sedimentation stabilizer to carry out non-programmed cryopreservation of the MSCs of an SD rat, and detecting the recovery rate, wherein the result is as shown in Table 3.

TABLE 3
comparison table for portions of cell sedimentation stabilizer
and cell recovery rates

| Component | Example | Amount | | | | |
|---|---|---|---|---|---|---|
| Cell membrane | Raffinose | 5.0% | | | | |
| protectant | | | | | | |
| Permeable | DMSO | 5.0% | | | | |
| intracellular | | | | | | |
| protectant | | | | | | |
| Antioxidant | Vitamin C | 4.0% | | | | |
| Cell sedimentation | Methyl | 1.0% | 3.0% | 16% | 23% | 35% |
| stabilizer | cellulose | | | | | |
| | 4000CP | | | | | |
| | Hydroxyethyl | 1.0% | 3.0% | 17% | 23% | 35% |
| | starch | | | | | |

| | | |
|---|---|---|
| Cell nutritional | Glutamine | 2.0% |
| agent | Sodium | 2.0% |
| | pyruvate | |
| pH buffer solution | PBS | The balance |

| | | | | | |
|---|---|---|---|---|---|
| Cell recovery rate (%) | 62.5 | 94.3 | 95.2 | 93.4 | 79.8 |

In Table 3, the methyl cellulose 4000 CP and the hydroxyethyl starch are used separately.

From the data in Table 3, it can be seen that the cell recovery rate is relatively higher when the amount of the cell sedimentation stabilizer is between 3.0% and 23%; based on an overall consideration, the amount of the cell sedimentation stabilizer preferably is between 2.0% and 25% in the cell cryopreservation solution of the invention.

Experimental Data

Comparison of Recovery Rate

Using the cell cryopreservation solution of the invention/the conventional cryopreservation solution to carry out non-programmed cryopreservation/programmed cryopreservation and non-programmed cryopreservation of MSCs, CNCs and ESCs, then detecting the cell recovery rate, wherein the result is as shown in Table 4.

TABLE 4
comparison table for different cryopreservation solutions/cryopreservation
methods and cell recovery rates

| | | | ESCs |
|---|---|---|---|
| | MSCs | ADSCs | (MEF-FREE) |
| A: cell cryopreservation | 94% | 78% | 94% |
| solution of the invention | | | |
| (non-programmed | | | |
| cryopreservation) | | | |
| B: conventional | 90% | 46% | 88% |
| cryopreservation | | | |
| solution (programmed | | | |
| cryopreservation) | | | |
| C: conventional | 68% | 10% | 43% |
| cryopreservation | | | |
| solution | | | |
| (non-programmed | | | |
| cryopreservation) | | | |

From the data in Table 4, it can be seen that the cryopreservation effect of the conventional cryopreservation solution in programmed-cryopreservation is apparently better than that in non-programmed cryopreservation, while the cell recovery rate of the cell cryopreservation solution of the invention in non-programmed cryopreservation is apparently higher than that of the conventional cryopreservation solution in programmed-cryopreservation; thus, the cell cryopreservation solution of the invention has an obvious advantage.

Comparison of Cell Fecundity

Using the cell cryopreservation solution of the invention/the conventional cryopreservation solution to carry out non-programmed cryopreservation/programmed cryopreservation and non-programmed cryopreservation of MSCs of an SD rat; after the MSCs are recovered, inoculating 1×105 cells to each type of MSCs and culturing them for 7 days, calculating the number of cells everyday and drawing a growth curve, wherein the growth curve is as shown in FIG. 1. From FIG. 1, it can be seen that the cell proliferation rate of the conventional cryopreservation solution in non-programmed cryopreservation is the lowest, the cell proliferation rate of the conventional cryopreservation solution in programmed cryopreservation is relatively higher, and the cell proliferation rate of the cell cryopreservation solution of the invention in non-programmed cryopreservation is the highest; thus, the cell cryopreservation solution of the invention has the best effect.

Impact of Different Cell Cryopreservation Solutions on Cell Differentiation Ability

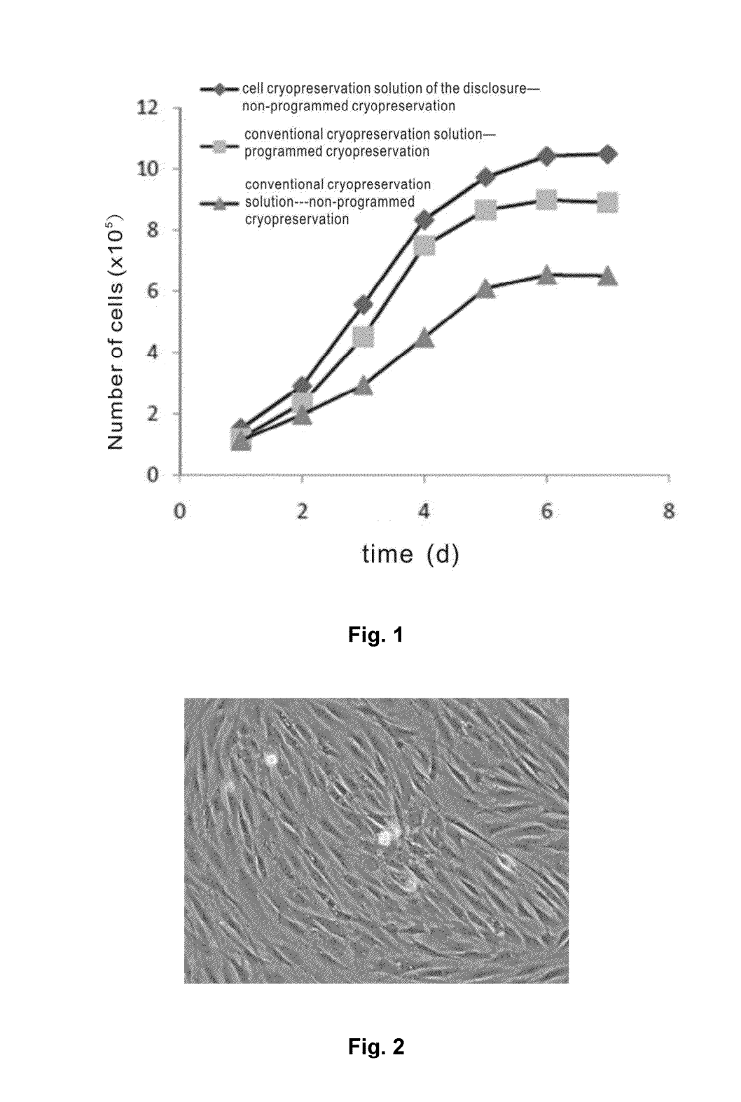

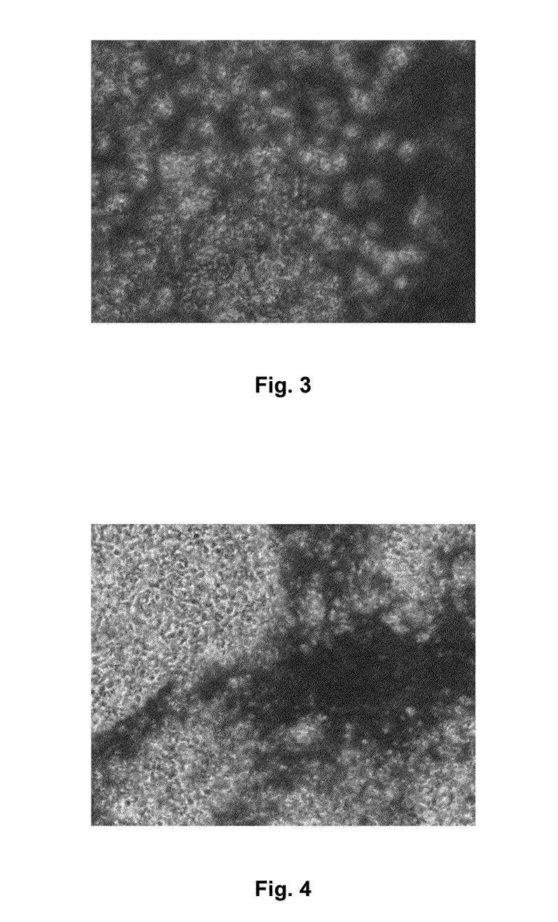

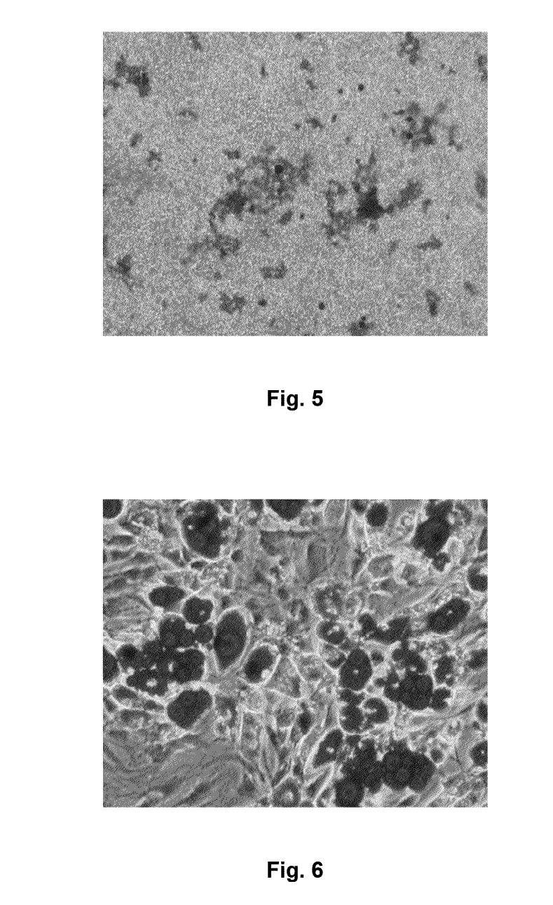

Using the cell cryopreservation solution of the invention/the conventional cryopreservation solution to carry out non-programmed cryopreservation/programmed cryopreservation and non-programmed cryopreservation of MSCs of an SD rat; after the MSCs are recovered, using an inducing solution to carry out osteoblast induction and lipoblast induction; after the MSCs are induced, staining the cells to observe, wherein the cells subjected to 28 d osteoblast induction are stained by alizarin red and the cells subjected to 20 d lipoblast induction are stained by oil red 0, the result of cell induction is as shown in FIG. 3 to FIG. 8, in which, FIG. 2 shows a cells diagram of non-induced MSCs of the SD rat; FIG. 3 shows a cells diagram of the MSCs of the SD rat subjected to osteoblast induction for 28 d after the MSCs are recovered from the non-programmed cryopreservation of the cell cryopreservation solution provided by the invention; FIG. 4 shows a cells diagram of the MSCs of the SD rat subjected to osteoblast induction for 28 d after the MSCs are recovered from the programmed cryopreservation of the conventional cell cryopreservation solution; FIG. 5 shows a cells diagram of the MSCs of the SD rat subjected to osteoblast induction for 28 d after the MSCs are recovered from the non-programmed cryopreservation of the conventional cell cryopreservation solution.

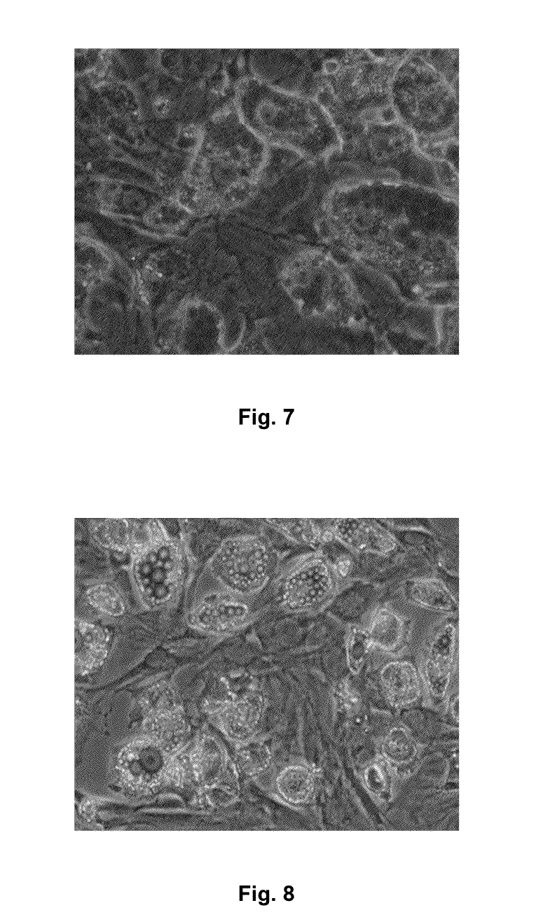

FIG. 6 shows a cells diagram of the MSCs of the SD rat subjected to lipoblast induction for 20 d after the MSCs are recovered from the non-programmed cryopreservation of the cell cryopreservation solution provided by the invention; FIG. 7 shows a cells diagram of the MSCs of the SD rat subjected to lipoblast induction for 20 d after the MSCs are recovered from the programmed cryopreservation of the conventional cell cryopreservation solution; and FIG. 8 shows a cells diagram of the MSCs of the SD rat subjected to lipoblast induction for 20 d after the MSCs are recovered from the non-programmed cryopreservation of the conventional cell cryopreservation solution.

From the figures, it can be seen that the cell cryopreservation solution of the invention has no impact on the differentiation ability of cells, and the cryopreservation effect is apparently higher than that of the programmed cryopreservation of the conventional cell cryopreservation solution.

What is claimed is:

1. A protein-free solution for cell cryopreservation, comprising 1.0-23 w/v % of cell membrane protectant, 1.0-16 w/v % of permeable intracellular protectant, 2.0-25 w/v % of cell sedimentation stabilizer, and the balance of solvent.

2. The protein-free solution for cell cryopreservation according to claim 1, further comprising 0.1-0.4 w/v % of antioxidant.

3. The protein-free solution for cell cryopreservation according to claim 1, further comprising 0.3-2.0 w/v % of cell nutritional agent.

4. The protein-free solution for cell cryopreservation according to claim 1, wherein the cell membrane protectant comprises non-reducing disaccharide, polysaccharide and sugar anhydride.

5. The protein-free solution for cell cryopreservation according to claim 4, wherein the non-reducing disaccharide comprises trehalose and cane sugar.

6. The protein-free solution for cell cryopreservation according to claim 1, wherein the polysaccharide comprises raffinose, xylose and panose.

7. The protein-free solution for cell cryopreservation according to claim 1, wherein the sugar anhydride comprises low-molecular sugar anhydride-40, middle-molecule sugar anhydride-70 and high-molecule sugar anhydride-500.

8. The protein-free solution for cell cryopreservation according to claim 1, wherein the permeable intracellular protectant comprises Dimethyl Sulfoxide (DMSO), propylene glycol and glycerin.

9. The protein-free solution for cell cryopreservation according to claim 1, wherein the cell sedimentation stabilizer comprises methylcellulose, hydroxyethyl starch, dextrin and soluble starch.

10. The protein-free solution for cell cryopreservation according to claim 1, wherein the pH of the pH buffer solution is between 7.2 and 7.4.
